(19) United States
(12) Patent Application Publication
(10) Pub. No.: US 2007/0143705 A1
(43) Pub. Date: Jun. 21, 2007

(54) Indexed scrollbar

(75) Inventor: Johan C. Peters, Sankt-Leon Rot (DE)

Correspondence Address: KENYON & KENYON LLP, 1500 K STREET N.W., WASHINGTON, DC, 20005, US

(73) Assignee: SAP AG

(21) Appl. No.: 11/304,712

(22) Filed: Dec. 16, 2005

(51) Int. Cl. G06F 9/00

(52) U.S. Cl. 715/786

(57) ABSTRACT

Embodiments of the present invention relate to an indexed scrollbar for document navigation. The scrollbar may comprise a plurality of indicators corresponding to a document structure. By selecting an indicator with an input device, a document viewer may jump to a corresponding portion of the document immediately without having to scroll through preceding portions.

### BACKGROUND OF THE INVENTION

Electronic documents can be quite lengthy. A viewer of an electronic document may, therefore, become frustrated by having to scroll through long stretches of a document before finding the part he or she is interested in. Accordingly, it would be beneficial to provide the viewer of an electronic document with a way to see the structure of the document at a glance and to be able to quickly jump to parts of the document that he/she wants to view.

Document mapping functionality is known. For example, a “Document Map” function is available in Microsoft® Word. The Document Map function identifies headings in a document and presents them serially in a pane next to the document. Clicking on a given heading causes a jump to the corresponding document portion.

However, there is some inconvenience associated with use of the Document Map function. For example, it requires a manual toggling on/off operation to activate/deactivate. Moreover, there is no information in the document structure derived by the function about the relative sizes of document sections.

### BRIEF DESCRIPTION OF THE DRAWINGS

FIGS. 1A-1C show an indexed scrollbar according to embodiments of the present invention;

FIG. 2 shows a computer system according to embodiments of the present invention; and

FIG. 3 shows a process flow according to embodiments of the present invention.

### DETAILED DESCRIPTION

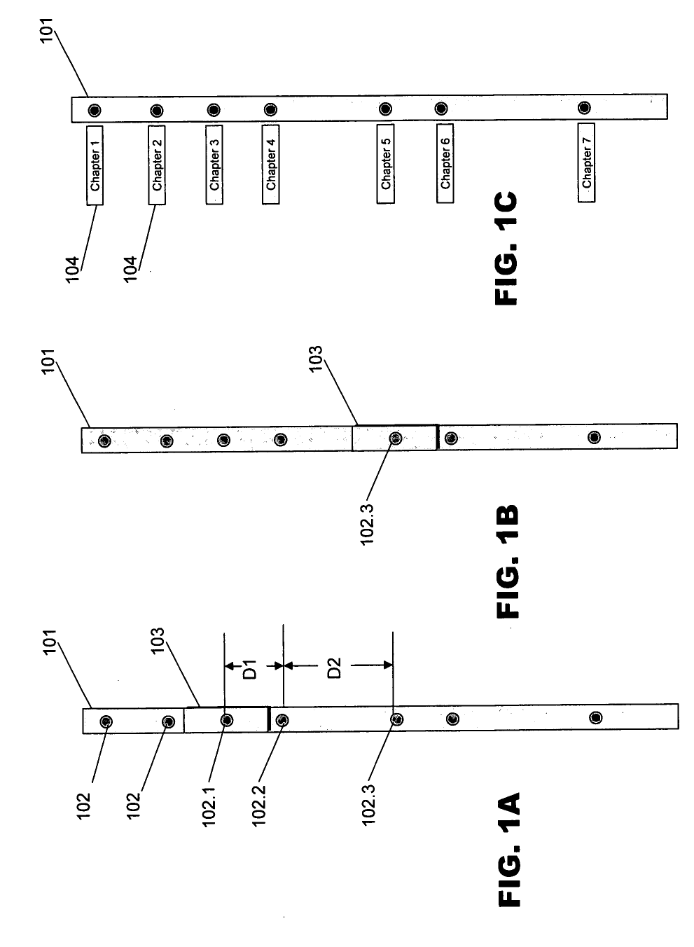

In view of the above considerations, embodiments of the present invention relate to an indexed scrollbar for document navigation. FIG. 1A shows a representation of the indexed scrollbar. The scrollbar 101 may comprise a plurality of indicators 102 distributed along its length. The indicators 102 may correspond to a document structure. For example, they may demarcate document sections or other structures. A distance between indicators may indicate, for example, a relative size of a section. By presenting this information in graphical form in a single display screen, a user may obtain a useful level of understanding of the document at a glance. Moreover, by activating an indicator 102 with an input device, the user may jump to a corresponding portion of the document immediately without having to scroll through preceding portions.

A sliding or displaceable scrolling button 103, which may be a field defined within the scrollbar 101, may track and highlight indicator selections. That is, after a user selects an indicator 102, the scrolling button 103 may automatically move to the selected indicator and highlight it. FIG. 1B, for example, shows the button 103 moved from a previous position, where it framed or highlighted selected indicator 102.1, to another position, where it highlights selected indicator 102.3. Alternatively, to select an indicator, the user may drag the scrolling button 103 to the indicator. The scrolling button 103 may also be dragged to a position intermediate between indicators.

The indicators 102 may further be associated with descriptors 104, as shown in FIG. 1C. The descriptors may provide information about the portion of the document pointed to by a particular indicator. In the example of FIG. 1C, the descriptors are chapter headings. The descriptors may be normally non-displayed, but be displayed, for example, when associated indicators are pointed to with an input device such as a mouse.

As noted earlier, the indicators 102 may correspond to a document structure. For example, each indicator may point to the beginning of a document section or other structural feature of a document. The indicators may therefore show relative sizes of document sections. For example, referring to FIG. 1A, a distance D1 between a first indicator 102.1 and a second indicator 102.2, as compared to a distance D2 between the second indicator 102.2 and a third indicator 102.3, shows the relative sizes of the document sections respectively demarcated by indicators 102.1 to 102.2, and 102.2 to 102.3.

As further noted earlier, a user may activate an indicator 102 with an input device to cause a jump to a corresponding portion of the document (e.g., the beginning of a document section). Because many documents will contain multiple pages, and thus not be displayable in a single display screen, in order to show the structure of the document as whole only portions of document sections may be displayed in the single display screen. For example, in embodiments, only the part of the document that corresponds with the position of the scrolling button 103 may be displayed. A user may perform further operations to cause a selected document portion to be viewable in its entirety.

The indexed scrollbar according to embodiments of the present invention may be incorporated into any kind of computer display. Behavior of the display, including jumps to document sections indexed by indicators, may be governed at least in part by computer-executable instructions according to embodiments of the present invention. The instructions may generate, possibly in association with or by interfacing with conventional code that controls aspects of a display's appearance, a display on a display device, where the display includes an indexed scrollbar according to embodiments of the invention. The indexed scrollbar may correspond to an electronic document, one or more portions of which may be displayed on the display device.

The electronic document may include various tokens, tags, specialized navigation and definitional fields, and the like, defining a navigable structure for the document, in a manner well known in the art. Such fields may be interpreted by the instructions, or by conventional code that interfaces with the instructions, to generate a corresponding distribution of indicators for display in the scrollbar. Further, the instructions, or conventional code that interfaces with the instructions, may receive input signals from a mouse or other input device and perform corresponding operations. For example, a user may select an indicator 102 by positioning a pointer or cursor or other positional indicator over the indicator 102 and clicking on it. This may cause the scrolling button 103 to be re-positioned over the selected indicator. Alternatively, the user may drag the scrolling button 103 to a selected indicator. Such operations may generate selection signals to the instructions, or conventional code that interfaces with the instructions.

In response to the signals, the instructions, or conventional code that interfaces with the instructions, may interpret the specialized fields in the document to shift internal pointers from a previous document section to the section corresponding to the selected indicator, in a manner well known in the art. Based on the shift in internal pointers, the instructions, or conventional code that interfaces with the instructions drive, may highlight the selected indicator and a portion of the corresponding document section, such as a section header. In response to further operations by the user, the instructions, or conventional code that interfaces with the instructions, may cause the section, which may comprise content that to be fully displayed requires a plurality of successive screen displays, to be available for display and scrolling.

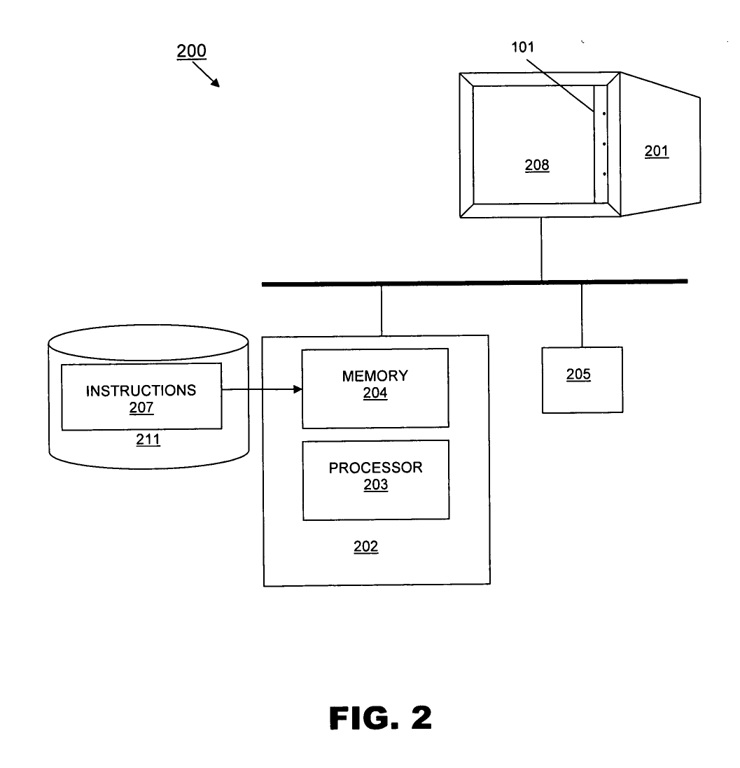

FIG. 2 shows a system 200 wherein embodiments of the present invention may find advantageous application. The system 200 may comprise a display device 201. The display device 201 may be coupled to a computer 202 comprising a processor 203 and memory 204. The computer 202 may further be coupled to an input device 205 such as a mouse or keyboard.

Computer-executable instructions 207 according to embodiments of the present invention may be stored on any machine-readable medium 211, such as RAM (random access memory), ROM (read-only memory), floppy disk, fixed disk, CD-ROM, magnetic tape and the like. The instructions may be loaded from the machine-readable medium 211 into the memory 204 for execution by the processor 203. As noted previously, the instructions may interface with conventional code that controls aspects of a display's appearance.

The instructions 207, or conventional code that interfaces with the instructions, may generate a display 208 on the display device 201. The display 208 may include an indexed scrollbar 101 according to embodiments of the present invention, along with at least a portion of a corresponding electronic document. With the input device 205, a user may activate features of the scrollbar, such as selecting an indicator to jump to the corresponding document section. These activities may generate signals from the input device 205 that are detected by the computer 202. The instructions 207, or conventional code that interfaces with the instructions, may be responsive to the signals detected by the computer 202 and generate a corresponding display on the display device 201.

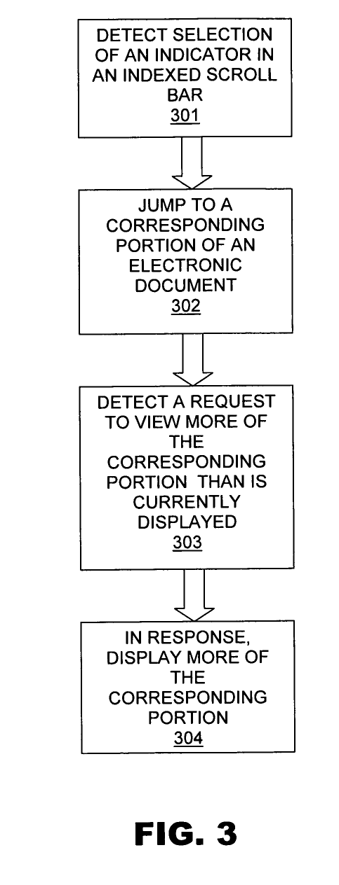

FIG. 3 shows a process flow according to embodiments of the present invention. As shown in block 301, a selection of an indicator in an indexed scrollbar of a computer display may be detected. In response, a jump to a corresponding portion of an electronic document may be performed, as shown in block 302. The selected indicator may be highlighted.

Subsequently, signals may be detected indicating a request to view more of the corresponding portion than is currently displayed, as shown in block 303. In response, more of the corresponding portion may be displayed, as shown in block 304.

In view of the above discussion, embodiments of the present invention further relate to a user interface for a document, and methods of applying the user interface. For example, in a method according to embodiments of the invention, by way of a user interface according to embodiments of the present invention, a user may open a document in a computer application program, and display contents of the document in an application window. The display may include a scrollbar in the application window as a navigational control element of the user interface.

The method may further include identifying headings within the document, e.g. by way of descriptors 104, and displaying indicators of the headings on the scrollbar. The indicators may be in positions corresponding to positional relationships of the headings within the document.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method comprising:
generating a display on a display device, the display including an indexed scrollbar comprising a plurality of indicators corresponding to a document structure; and
in response to selection of an indicator, jumping to a corresponding portion of the document.

2. The method of claim 1, further comprising highlighting the selected indicator.

3. The method of claim 1, further comprising displaying the corresponding portion of the document.

4. The method of claim 1, further comprising displaying a descriptor associated with an indicator.

5. A machine-readable medium storing instructions to perform a method according to claim 1.

6. A system comprising:
a display device; and
a computer coupled to the display device, the computer to generate a display on the display device, the display including a indexed scrollbar comprising a plurality of indicators representing a document structure;
wherein an indicator is responsive to selection thereof to jump to a corresponding portion of the document.

7. The system of claim 6, further comprising an input device, the input device to generate signals to the computer indicative of the selection.

8. The system of claim 6, wherein the indexed scrollbar comprises a displaceable field to select an indicator.

9. The system of claim 6, wherein an indicator is associated with a descriptor displayable upon manipulation of the indicator.

10. The system of claim 6, wherein respective distances between indicators indicate relative sizes of corresponding document sections.

11. A method comprising:
detecting selection of an indicator in an indexed scrollbar of a computer display; and
in response, jumping to a corresponding portion of an electronic document.

12. The method of claim 11, further comprising:
highlighting the selected indicator.

13. The method of claim 12, further comprising:
detecting a request to view more of the corresponding portion of the electronic document than is currently displayed; and
in response, displaying more of the corresponding portion.

14. A machine-readable medium storing instructions to perform a method according to claim 11.

15. A user interface method for a document, comprising:
opening a document in a computer application program,
displaying document contents in an application window,
displaying a scrollbar in the application window as a navigational control element of the user interface,
identifying headings within the document, and
displaying indicators of the headings on the scrollbar in positions corresponding to positional relationships of the headings within the document.

16. The method of claim 15, further comprising:
in response to selection of an indicator, jumping to a corresponding document heading.

17. A machine-readable medium storing instructions to perform a method according to claim 15.
